(19) United States
(12) Patent Application Publication
(10) Pub. No.: US 2026/0288142 A1
(43) Pub. Date: Sep. 24, 2026

(54) SYSTEMS AND METHODS FOR A SECURE MILLIMETER-WAVE MARKING SYSTEM FOR LOW-ALTITUDE WEATHER-RESILIENT UAV OPERATIONS

(71) Applicants: Dajiang Suo, Mesa, AZ (US); Manuel Garcia, Tempe, AZ (US); Marco Vincenzi, Tempe, AZ (US); Shaozu Ding, Gilbert, AZ (US)

(72) Inventors: Dajiang Suo, Mesa, AZ (US); Manuel Garcia, Tempe, AZ (US); Marco Vincenzi, Tempe, AZ (US); Shaozu Ding, Gilbert, AZ (US)

(73) Assignee: Arizona Board of Regents on Behalf of Arizona State University, Tempe, AZ (US)

(21) Appl. No.: 19/572,560

(22) Filed: Mar. 19, 2026

Related U.S. Application Data
(60) Provisional application No. 63/774,988, filed on Mar. 20, 2025.

(51) Int. Cl. G05D 1/244; G05D 1/622; G05D 109/25; G05D 111/30; H01Q 15/00

(52) U.S. Cl. CPC G05D 1/2446; G05D 1/622; H01Q 15/0013; G05D 2109/254; G05D 2111/30

(57) ABSTRACT

A multi-dimensional fiducial marking system leveraging millimeter-wave (mmWave) technology addresses critical challenges in urban UAV navigation and localization. Unlike traditional visual fiducial markers, the system offers enhanced security through novel data encoding schemes and robust performance in adverse weather conditions. By integrating individual dielectric reflectors with frequency-selective surfaces into modular arrays, the system encodes spatial and identity information for tamper resistance and authentication. The system enables precise UAV navigation and pose estimation using mmWave radar, providing a secure and weather-resilient solution for urban air mobility applications.

### CROSS-REFERENCE OF RELATED APPLICATIONS

This is a non-provisional application that claims benefit to U.S. Provisional Application No. 63/774,988 filed on Mar. 20, 2025, which is herein incorporated by reference in its entirety.

### FIELD

The present disclosure generally relates to air mobility and guidance systems for unmanned aerial vehicles, and particularly to a multi-dimensional fiducial marking system and associated methods for enhancing security and robustness of UAV operations in urban environments.

### BACKGROUND

Existing fiducial markers for UAV navigation face significant limitations in dense urban environments, including vulnerability to adverse weather, tampering, and urban clutter.

It is with these observations in mind, among others, that various aspects of the present disclosure were conceived and developed.

### BRIEF DESCRIPTION OF THE DRAWINGS

FIG. 1 is a simplified diagram showing usage scenarios of a Millimeter-Wave Marking System outlined herein;

FIG. 2 is a diagram showing an example of corner reflectors featuring multi-facet design and frequency-selective capabilities;

FIG. 3 is an illustration showing an example reflector array encoded with marker ID and security checksum for tampering detection; and

FIG. 4 is a simplified diagram showing an example computing device for implementation of aspects of an unmanned aerial vehicle that can interface with the systems outlined herein.

FIG. 5 is an image showing the designated marker that utilizes a matrix of corner reflectors in the form of small pyramids.

FIG. 6 is a representation of ArUco ID number 24.

FIG. 7 is an image of a Python CV debug image output.

Corresponding reference characters indicate corresponding elements among the view of the drawings. The headings used in the figures do not limit the scope of the claims.

### SUMMARY

In some aspects, the techniques described herein relate to a system, including: a dielectric reflector arranged along a surface and having a frequency-selective surface that encodes one or more of spatial, identity, and security-critical information readable by a radar device of an unmanned aerial vehicle.

In some aspects, the techniques described herein relate to a system, the dielectric reflector including a plurality of internal layers covered by frequency selective surfaces that selectively filter mmWave radar signals within a specified sub-band resulting in a unique spectral signature readable by the unmanned aerial vehicle.

In some aspects, the techniques described herein relate to a system, the dielectric reflector being one of a plurality of dielectric reflectors arranged in a reflector array pattern and having a unique spatial arrangement.

In some aspects, the techniques described herein relate to a system, the reflector array pattern encoding one or more of spatial, identity, and security-critical information readable by the unmanned aerial vehicle. The dielectric reflector can form part of a façade of a building.

In some aspects, the techniques described herein relate to a system, further including: a processor in communication with a memory onboard the unmanned aerial vehicle, the processor being in communication with the radar device, and the memory including instructions executable by the processor to: generate, at the radar device of an unmanned aerial vehicle, a radar signal; measure, at the radar device, a response signal from a dielectric reflector arranged along a surface; and decode one or more of spatial, identity, and security-critical information based on the response signal.

In some aspects, the techniques described herein relate to a system, the memory further including instructions executable by the processor to: evaluate an angle of arrival (AoA) measurement for the unmanned aerial vehicle based on a phase shift between the response signal arriving at a first antenna of the radar device and a second antenna of the radar device; and determine, based on the AoA measurement and a set of range data derived from a time-of-flight of the radar signal, a 3D position and orientation of the unmanned aerial vehicle relative to the dielectric reflector.

In some aspects, the techniques described herein relate to a system, the memory further including instructions executable by the processor to: generate a control input for application to an actuator of the unmanned aerial vehicle based on one or more of spatial, identity, and security-critical information obtained from the response signal.

In some aspects, the techniques described herein relate to a system, wherein the dielectric reflector specifies lateral and vertical offsets for collision avoidance and trajectory alignment for the unmanned aerial vehicle with respect to a structure associated with the dielectric reflector.

In some aspects, the techniques described herein relate to a system, wherein the dielectric reflector specifies a security value for verification of authenticity of the dielectric reflector by the unmanned aerial vehicle.

In some aspects, the techniques described herein relate to a method, including: generating, at a radar device of an unmanned aerial vehicle, a radar signal; measuring, at the radar device, a response signal from a dielectric reflector arranged along a surface; and decoding, at a processor of the unmanned aerial vehicle, one or more of spatial, identity, and security-critical information based on the response signal.

In some aspects, the techniques described herein relate to a method, further including: evaluating, at the processor, an angle of arrival (AoA) measurement for the unmanned aerial vehicle based on a phase shift between the response signal arriving at a first antenna of the radar device and a second antenna of the radar device; and determining, at the processor and based on the AoA measurement and a set of range data derived from a time-of-flight of the radar signal, a 3D position and orientation of the unmanned aerial vehicle relative to the dielectric reflector.

In some aspects, the techniques described herein relate to a method, further including: determining, at the processor and based on the response signal, one or more of a lateral offset and a vertical offsets for collision avoidance and trajectory alignment for the unmanned aerial vehicle with respect to a structure associated with the dielectric reflector.

In some aspects, the techniques described herein relate to a method, further including: generating a control input for application to an actuator of the unmanned aerial vehicle based on one or more of spatial, identity, and security-critical information obtained from the response signal.

In some aspects, the techniques described herein relate to a method, including: forming, by an additive-manufacturing method, a dielectric reflector for arrangement along a surface, the dielectric reflector having a frequency-selective surface that encodes one or more of spatial, identity, and security-critical information readable by a radar device of an unmanned aerial vehicle.

In some aspects, the techniques described herein relate to a method, the dielectric reflector including a plurality of internal layers covered by frequency selective surfaces that selectively filter mmWave radar signals within a specified sub-band resulting in a unique spectral signature readable by the unmanned aerial vehicle.

### DETAILED DESCRIPTION

Urban air mobility faces significant challenges in dense urban environments where UAVs rely on visual fiducial markers for navigation and precision landing. Adverse weather conditions, low visibility, and urban clutter limit the safety of these visual markers. To address these limitations, the present disclosure introduces a millimeter-wave (mmWave) fiducial marking system which can be seamlessly integrated into urban infrastructure. These markers enable robust, weather-resilient UAV operations by combining cyber components, such as UAV-mounted sensing and data encoding, with physical urban structures, including building facades, bridges, and utility poles. The system adheres to architectural and environmental guidelines, ensuring it is non-obtrusive and visually harmonious with the urban environment. Additionally, the markers incorporate embedded security mechanisms to mitigate risks of tampering and misplacement, encoding localization and verification data for enhanced operational safety and integrity.

Existing fiducial markers for UAV navigation, such as AprilTag or Aruco, face significant limitations in dense urban environments, including vulnerability to adverse weather, tampering, and urban clutter. While previous work has explored weather-resilient solutions, the systems outlined herein uniquely address the critical challenge of security. The present disclosure outlines a multi-dimensional marking system that combines enhanced security mechanisms with robustness to extreme weather and tampering. The marking system uses mmWave technology to encode spatial, identity, and security-critical information into modular reflector arrays. These arrays seamlessly integrate into urban infrastructure, ensuring safe and secure UAV operations while providing tamper detection and resilience against environmental degradation.

The integration of mmWave markers transforms fiducial markers from passive aids into active components of UAV control loops, particularly under adverse weather conditions. For example, during precision landings, the markers provide real-time localization and descent guidance, such as optimal approach angles and velocity thresholds, ensuring safe and accurate touchdown in rain or fog. In low-altitude cruising, markers guide UAVs to maintain safe distances from urban structures like bridges and transmission lines, actively supporting collision avoidance and trajectory alignment. Furthermore, the markers' tamper-resistant encoding schemes enable UAVs to verify marker authenticity and detect tampering, ensuring secure and reliable operations in critical scenarios such as infrastructure inspections or emergency response.

The systems and techniques outlined herein advance the field of cyber-physical systems (CPS) by integrating emerging cyber technologies—sensing, computation, and communication—into urban environments through IoT-enabled mmWave fiducial markers that act as critical interfaces between UAV systems and dynamic urban infrastructure. Localization and security-related data are encoded into the markers by precisely manipulating their geometry, materials, and electromagnetic properties, ensuring reliable information exchange and tamper resistance. Further, the systems outlined herein address key CPS challenges in security, safety, and adaptability. The markers enable UAVs to authenticate navigation data, detect tampering, and maintain safe operations in adverse weather conditions and dense urban environments. Their modular design supports seamless integration into diverse urban structures, facilitating precision landings, low-altitude navigation, and long-range guidance. By embedding CPS technologies into urban air mobility systems, this research establishes a scalable framework for secure, sustainable, and resilient UAV operations.

The systems outlined herein support societal goals of enhancing safety, sustainability, and public trust in urban air mobility. The system's non-obtrusive design promotes public acceptance by aligning with architectural and environmental standards, preserving urban aesthetics while advancing technological innovation. Additionally, the tamper-resistant design enhances the resilience of UAV systems against intentional tampering and misplacement, fostering trust in critical applications.

### System Overview

A marking system includes individual dielectric reflectors with frequency-selective surfaces (FSS) that enable precise manipulation of millimeter-wave signals. Each reflector is designed to achieve retroreflectivity through dielectric material properties and geometric configurations, ensuring omnidirectional performance. These individual reflectors can be modularly combined into arrays, enhancing reflectivity and expanding their functionality.

Data Encoding and Security Mechanisms include:

Spatial Encoding: Individual markers are spatially arranged into distinct patterns, with each arrangement encoding unique identity or security information. For example, a 3×3 grid of reflectors can represent binary data, with “1” corresponding to a reflector and “0” corresponding to an empty cell. This allows UAV-mounted radar systems to decode the spatial arrangement for identification and verification.

Frequency Encoding: The frequency-selective surface (FSS) of each reflector enables encoding additional data within specific frequency bands. For instance, reflectors can be designed to resonate at distinct frequencies (e.g., 76 GHz or 79 GHz), effectively embedding additional layers of information. Combining spatial and frequency encoding significantly enhances the system's data capacity while ensuring resilience to tampering and environmental interference.

Pose Estimation and Navigation: The system enables UAV-mounted radar to perform pose estimation through direct measurement of distance and angle of arrival (AoA) from the reflector array. Unlike visual fiducial markers, which rely on computationally intensive Perspective-n-Point (PnP) algorithms, this system calculates UAV orientation (yaw, pitch, roll) directly from range and angular relationships between reflectors. For example, by using a planar antenna array, the UAV radar measures phase shifts and time delays in the reflected signal to compute the UAV's position and orientation relative to the marker. This efficient algorithm reduces computational overhead while maintaining centimeter-level localization accuracy.

Enhanced Security through Multi-Dimensional Data Encoding: The invention uniquely combines frequency-selective surfaces on individual dielectric reflectors with spatial encoding achieved by arranging groups of reflectors into specific patterns. This multi-dimensional data encoding ensures tamper resistance, identity verification, and significantly higher data capacity. The combination of these encoding mechanisms provides robust security benefits, allowing the system to detect tampering and authenticate markers in real-time.

Mosaic-Like Modular Design: The modular reflectors are designed to form customizable, mosaic-like arrays that can seamlessly integrate into urban infrastructure while adhering to architectural guidelines. This adaptability ensures that the marking system remains visually unobtrusive and aesthetically aligned with the built environment, supporting sustainable and discreet urban integration.

Example Use Case: Consider an urban rooftop equipped with a modular reflector array. The array consists of individual dielectric reflectors arranged in a unique spatial pattern, with each reflector tuned to specific frequencies. A UAV approaching the rooftop scans the array with its mmWave radar. It decodes the spatial pattern for identification, verifies authenticity via frequency-encoded security data, and estimates its pose based on distance and AoA measurements. The UAV then uses this information to execute a safe and precise landing, even under heavy rain or fog.

The systems outlined herein offer significant advantages over traditional fiducial markers, including:

Security Benefits: The novel encoding schemes enable tamper resistance and identity verification, addressing critical vulnerabilities in existing systems.

Weather Resilience: The mmWave technology ensures reliable performance in adverse conditions, such as rain, fog, and low visibility.

Architectural Integration: The modular, mosaic-like design ensures seamless integration into urban infrastructure, maintaining aesthetic and environmental compliance.

Computational Efficiency: The radar-based pose estimation algorithm eliminates the need for complex visual feature matching, enabling real-time UAV localization with reduced processing requirements.

### Motivations and Objectives

The present disclosure addresses challenges at the intersection of cyber and physical systems (CPS), focusing on enhancing unmanned aerial vehicle (UAV) operations in dense urban environments. Current reliance on visual fiducial markers for UAV navigation and precision landing is limited by vulnerability to adverse weather conditions, low visibility, and urban clutter. These limitations hinder the reliability and safety of UAV operations. Fiducial markers built from millimeter-wave (mmWave) sensing technologies, leveraging their ability to penetrate fog, rain, and dust while maintaining high accuracy in distance and velocity measurements when combined with vision-based approaches, offer a robust solution, enabling precise navigation and landing under diverse environmental conditions. This research integrates cyber components—such as UAV-mounted sensing, data encoding schemes, and backscattered signal processing—with physical elements, including urban infrastructure and additive-manufactured mmWave markers. The markers function as IoT-enabled interfaces, securely encoding navigation and security information while seamlessly adapting to diverse architectural and environmental conditions, thereby ensuring effective integration between UAV systems and urban infrastructure.

1. Enhancing safety in real-time UAV operations at low altitude. A marking system outlined herein supports a range of critical UAV operations, including precision landing on building rooftops or other designated urban areas, low-altitude cruising alongside civil infrastructure, and navigating through complex urban environments. For precision landing, the markers provide real-time localization data to enable accurate descent and touchdown. For low-altitude cruising, UAVs utilizes the encoded navigation data to maintain a safe distance from structures like bridges, high-voltage transmission lines, and other urban infrastructure. This ensures not only collision avoidance but also aids in deriving the lateral flight path needed for tasks such as infrastructure health monitoring or inspection. By providing reliable spatial and directional guidance, the marking system enables UAVs to follow optimal flight paths, allowing them to efficiently traverse along the length of structures without compromising safety.

2. Enable adaptability to specific operational requirements and environmental challenges. The modular design of the marking system allows adjustments in marker size to ensure visibility for UAVs at distances ranging from 50 meters for precision landings to less than 200 meters for long-range navigation. The encoding capacity can be tailored to include essential data, such as geolocation and security codes, while the modular structure facilitates integration with various infrastructure types, including flat building facades, curved utility poles, and bridge undersides. Additionally, the design enhances resilience to adverse weather conditions, such as heavy rain and fog, by enabling reconfiguration or augmentation to maintain reliable signal performance. This flexibility ensures that the system can meet diverse operational demands while blending seamlessly into urban environments.

3. Ensuring identity security and tamper resistance: Each marker integrates a novel data encoding scheme that securely embeds unique identity and verification information. This scheme enables UAVs to authenticate markers, mitigating risks of misplacement or intentional tampering by adversaries. By incorporating checksum regions into the encoded data, the system can promptly detect unauthorized modifications or physical damage, such as missing or altered components. This tamper-resistant design not only safeguards the integrity of the markers against environmental wear but also ensures resilience against deliberate acts of sabotage or misplacement, thereby enhancing the overall security of urban air mobility operations.

### CPS Research Focus

This research addresses the challenge of integrating future urban air mobility systems with UAVs equipped with advanced cyber components, such as sensing, computation, and communication modules, into urban physical environments that are dynamic and often unpredictable. The system outlined herein is IoT-enabled, and serves as the critical interface between these cyber components and the urban infrastructure, facilitating safe operations and protected data exchange. By bridging UAV-mounted emerging technologies with physical structures such as building tops and facades, bridges, and transmission lines, the system ensures reliable localization and navigation while maintaining harmony with the built environment.

The IoT-enabled markers are designed to enhance the safety and security of UAV operations in urban transportation. These markers support critical functions, including precision landing on rooftops, low-altitude cruising near infrastructure like bridges or transmission lines, and maintaining safe distances during infrastructure inspections. By encoding spatial, identity, and verification information, the markers enable UAVs to perform transportation-related tasks such as goods delivery, emergency response, and infrastructure health monitoring with high precision and safety, even under low visibility or adverse weather conditions.

The project also introduces a novel data encoding scheme implemented through arrays or millimeter wave reflectors seamlessly embedded into infrastructure, leveraging spatial and frequency-based encoding mechanisms to store and transmit critical localization and verification-related information. This design ensures tamper resistance, accurate identification, and consistent data exchange between UAVs and urban infrastructure without the need for external power. By addressing vulnerabilities such as misplacement, interference, environmental degradation, or even intentional tampering, the IoT-enabled cyber-physical system enhances the security and resilience of urban air transportation infrastructure.

### Related Work

### Visual Fiducial Markers for Autonomous System Operations.

Visual fiducial markers have been extensively used for UAV localization and pose estimation, especially in GPS-denied environments. These markers, such as AprilTag, ArUco, ARTag, and STag, provide easily recognizable reference points that can be detected by onboard cameras to calculate the UAV's position and orientation. AprilTag and ArUco markers are among the most commonly used for UAV navigation due to their robustness to lighting changes and motion blur. Additionally, AprilTag is favored for its error-correction capabilities and reliability in estimating poses from various angles. The combination of stereo cameras and fiducial markers is also effective for global position correction, enhancing the accuracy of visual-inertial odometry systems.

The process of vision-based pose estimation begins with tag detection, where the camera identifies a high-contrast rectangular shape in the field of view. Once detected, the camera samples the corners and contour of the tag to read its encoded binary pattern, which corresponds to a specific ID. After identifying the tag, pose estimation is performed to determine the UAV's position and orientation relative to the tag. Vision-based systems achieve pose estimation by solving a Perspective-n-Point (PnP) problem. The PnP algorithm takes the known 3D coordinates of the tag's corners (in the world frame) and the detected 2D positions of these corners in the image frame, using these points to compute the UAV's pose. This approach relies on visual feature matching and involves significant computational resources, especially in applications with multiple tags or varying environmental conditions.

While effective in clear conditions, vision-based tag detection has limitations in low visibility environments (e.g., fog, rain, or poor lighting), as visual clarity and contrast are essential for accurate detection. In adverse weather, the accuracy of vision-based pose estimation can degrade due to factors like reflections, glare, or visual obstructions. Despite these limitations, vision-based tags remain popular for applications requiring high spatial precision under favorable visibility conditions.

### Multimodal Markers for Autonomous System Operations.

To overcome challenges incurred by low visibility and adverse weather, markers that are built from multimodal sensing techniques have been explored. For example, ArUco-like multi-layered landing site made by combining thermal conductive (e.g., aluminum) and insulator (cork) can be detected and transformed into 2D point cloud by UAV-mounted Light Detection and Ranging (LIDAR). While allowing precise object detection and localization, even in poor lighting conditions, LiDAR-based landing site can still be affected by heavy rain or fog due to the small wavelength of LiDAR. On the other hand, mmWave radar markers, such as those designed with retroreflective structures, enhance radar detection under all-weather conditions, maintaining high detection ranges even in heavy rain, fog, or dust. Passive radar reflectors, such as the low-profile corner reflectors and chipless RFID tags, provide robust performance in GPS-denied environments and improve radar-based localization in urban settings by offering wider angular and distance coverage. Although their capability to function independently of lighting and weather conditions is essential for strengthening the reliability of autonomous navigation systems, the use of conductive materials only design introduce visual intrusion, and more importantly, there is a lack of security mechanisms for tamper detection or identity verification.

### Data Encoding Through Backscatter Communication and Chipless RFID.

The ability to encode data containing identity and security information is a critical requirement for the marking system, enabling unique identification, verification, and tamper detection. Drawing inspiration from backscatter communication mechanisms, as demonstrated in RFID systems, the marking system leverages the ability to encode information by reflecting and modulating incident radio waves without requiring an external power source. RFID, or Radio Frequency Identification, is widely used in applications such as inventory tracking and access control, where passive tags reflect signals from a reader to transmit stored data. While the marking system borrows the backscatter principle that enables low-power and cost-effective communication, it departs fundamentally from traditional RFID by eliminating the need for integrated circuits (ICs) or external electronic components. This focus on a chipless design allows for scalable, energy-efficient markers that can seamlessly integrate into urban infrastructure.

Recent advancements in backscatter-based technologies, particularly chipless systems, inform the design of the markers of the marking system. In chipless implementations, physical structures or material properties are tailored to encode data directly into the electromagnetic response, eliminating the complexity and cost of ICs. Encoding mechanisms such as frequency-domain modulation, where unique resonant frequencies correspond to specific data bits, and time-domain modulation, where delays in reflected signals encode information, allow for compact and robust data storage. These chipless markers harvest energy from incident radio waves, enabling long-term operation without external power. By adopting these mechanisms, the marking system achieves tamper-resistant identity verification and authentication while fundamentally differing from traditional RFID designs, which rely on chips and require more complex infrastructure.

The “chipless” nature of the markers of the marking system redefines how data encoding and communication are implemented for power-constrained applications. By encoding information within the geometric, physical, and electromagnetic properties of the markers, the system eliminates the need for integrated circuits and external power, making it an ideal solution for urban infrastructure design.

### Cyber and Physical System Design and Integration

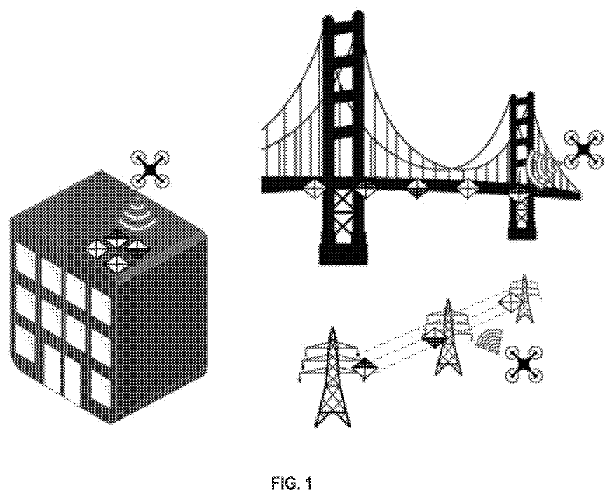

A key novelty of the marking system lies in the IoT-enabled interfacing layer that integrate cyber (i.e., information for low-altitude UAV operations) and physical components (i.e., urban infrastructure along the route of UAV landing and navigation). Including multifaceted corner reflector arrays that are made from merging dielectric and conductive material, the interface can be integrated into urban physical infrastructure, such as building roofs and facades or lateral surfaces of the bridge, without being obtrusive, while communicating with UAV-mounted mmWave radar to provide navigation information through backscatter communication. By interacting with the reflector array by using on-board radar, a UAV may extract useful information for localization and pose estimation, which will be used to control its maneuvers in low altitude. However, unlike QR code-like markers that are visually obtrusive to surrounding architecture, each individual reflector, which is made from dielectric and metallic materials (FIG. 1) and produced through additive manufacturing techniques, are discreet and can be arranged in custom patterns to suit various architectural guidelines, from building facades to bridges and transmission lines. Moreover, they can form mosaic-like arrays with various patterns, allowing for easy adaptation to different environments and ensuring the array remains visually discreet to maintain the sustainability of the built environment. In addition to addressing the safety and sustainability goals, the reflector arrays are also encoded with security-related information to mitigate risks associated with intentional tampering or misplacement with a newly developed data encoding scheme.

Individual multifaceted reflectors. Traditionally, corner reflectors (CRs) have been widely employed in maritime, hydrosphere monitoring, and satellite calibration applications to ensure that mmWave signals are reflected back in the same direction across a broad angular range. CRs with dihedral or trihedral structure can reflect waves back to the direction of the incident signal. However, these conventional designs may still fail to achieve retro-reflectivity covering the diverse approach directions of UAVs, particularly in scenarios such as UAV landings or when navigating under structures like bridges (as illustrated in FIG. 1). Additionally, vacuum-based CR structures, which coat only the internal surfaces with metallic materials to maintain efficient signal reflection, have limited capability for encoding additional information, such as marker identity and security data for tampering mitigation.

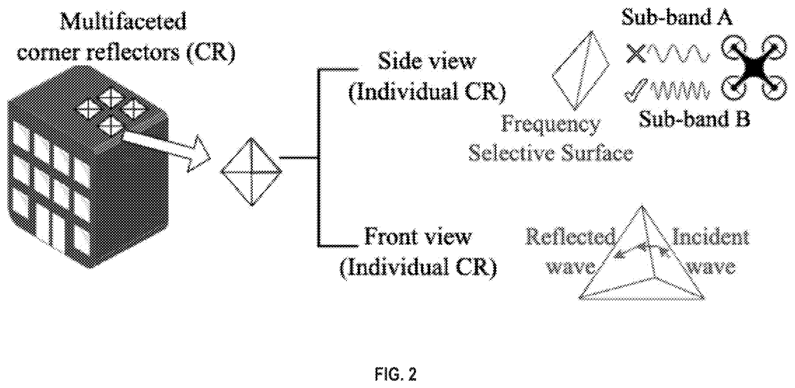

To address the challenges, multifaceted CRs that are incorporated with frequency filtering mechanisms and dielectric material are adopted as the foundational building blocks of the marking system, as shown in FIG. 2. Faceted façade designs have been widely adopted to give buildings a unique geometric aesthetic while making them adaptable to a changing environment. For example, the Media-ICT building located in Barcelona, Spain leverages a façade cover of inflatable cushions made from transparent polymer material to optimize energy use, while in Al Bahr Towers in Abu Dhabi, United Arab Emirates, the façade cover can be dynamically adjusted to changing weather conditions to reduce the solar gain in the building by 50%. The marking system outlined herein goes even further: architectural façade structures can be designed to have desired electromagnetic properties that backscatter mmWave signals sent by UAVs by carefully adjusting geometries, materials, and surface.

FIG. 2 illustrates CRs with internal layers covered by frequency selective surfaces (FSS). These FSS layers, marked by blue color, are engineered to selectively filter mmWave signals within specific sub-bands, providing precise control over which frequencies are reflected and which are attenuated. This design enables the CRs to function as both retro-reflectors and frequency-specific markers, facilitating the encoding of security and geolocation information. By integrating FSS into their internal layers, the CRs can distinguish between UAV signals operating on different frequency sub-bands (e.g., Sub-band A and Sub-band B, as shown in the figure), thereby ensuring compatibility with multi-channel UAV communication systems. Furthermore, as discussed in the next section, CRs with frequency-selective capabilities, when organized into an array, significantly enhance the overall data encoding capacity of the marker system.

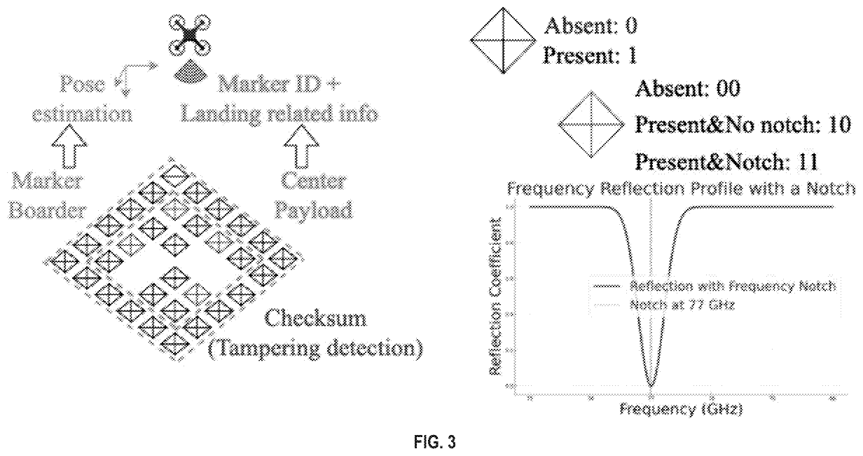

Reflector arrays and data encoding schemes. When used individually, the role of multifaceted CRs is limited to enhancing Radar Cross Section (RCS), which refers to the measure of how effectively an object reflects radar signals back to the source, improving signal detectability. To achieve additional functionality, such as encoding data for identification and security verification, arrays of multifaceted CRs can be organized into spatial patterns, as shown in FIG. 3.

For example, a 4×4 grid of multifaceted CRs, enclosed within the green boundary shown in FIG. 3, can serve as a center payload to spatially encode marker ID and landing information. Each cell in the grid can either contain a CR, representing “1,” or remain empty, representing “0,” forming a binary sequence that acts as a unique identifier for the marker. For instance, if reflectors are placed in cells (1,1), (1,3), (2,2), and (3,3), the resulting binary pattern “1010-0100-0010-0000” provides a distinct identifier for the marker. This spatial arrangement is analogous to the way QR codes or fiducial markers use visual patterns to encode unique data for optical recognition. A UAV-mounted radar scanning the marker can interpret this spatial pattern to identify and differentiate between markers. However, while this spatial encoding mechanism is effective for storing basic identifiers, its data capacity is inherently limited. As more reflectors are added to encode larger amounts of information, the physical size of the array must increase, which can make integration into compact urban environments challenging. This limitation highlights the need for an additional encoding mechanism to enhance capacity while maintaining compactness.

The integration of frequency encoding offers a practical solution to enhance the capacity of reflector arrays. Frequency encoding leverages materials or structures designed to reject or enhance specific frequencies of electromagnetic waves, embedding additional information within the reflected signal. There are two primary approaches to frequency encoding: frequency resonators and frequency-selective surfaces (FSS), which refers to engineered surfaces that can selectively reflect or transmit electromagnetic waves at specific frequencies while allowing others to pass through. While frequency resonators provide narrowband encoding with high precision, FSS is more suitable for UAV-mounted radar systems due to its ability to maintain a high RCS across wide incidence angles and long detection ranges (e.g., 20-40 meters). This capability ensures that the marker remains “visible” to radar under dynamic operating conditions. By combining frequency encoding with spatial encoding, the data capacity of reflector arrays can be significantly increased.

For instance, consider the same 4×4 reflector array discussed earlier, which is integrated with frequency-selective surfaces. The cells that are capable of frequency selection may encode checksum or verification information. While the identifier allows a UAV-mounted radar to distinguish between markers based on the spatial arrangement of reflectors, the checksum facilitates the detection of any tampering with the markers. If any part of the spatial pattern is tampered with or altered, the checksum will fail, signaling potential unauthorized. Reflectors in cells (1,1), (1,3), (3,1), and (3,4), which are highlighted in blue in FIG. 3, can be designed to introduce a frequency notch at 77 GHz, creating a unique spectral signature. A frequency notch is a selective reduction in reflectivity at a specific frequency, achieved by designing the FSS layer with resonant patterns, such as split-ring resonators or periodic slots, that absorb energy at the target frequency.

When the UAV scans the marker, it first identifies the spatial pattern of CR presence or absence to extract the binary identity information. It then analyzes the frequency response of individual reflectors to decode additional identity or security data. The encoding scheme could assign the absence of a CR at a given position to represent “00”, the presence of a CR without a frequency notch to represent “01”, and the presence of a CR with a frequency notch near 77 GHz to represent “10”.′

This dual encoding approach allows the UAV to cross-check spatial and spectral data against predefined rules to detect tampering or verify authenticity. For instance, if the spatial pattern dictates that specific cells must reflect certain frequencies, any discrepancy between the expected and detected frequencies indicates potential tampering. By merging spatial and spectral encoding, the marker becomes compact, highly informative, and tamper-resistant. This multi-dimensional encoding ensures robust performance across wide angles and distances, making it ideal for UAV precision landing, low-altitude navigation, and secure integration into urban infrastructure.

The modularized design of the reflector arrays offers flexibility in forming marking systems of different sizes and scales. For instance, a small-scale marker array can be constructed using a 6×6 arrangement of CRs for close-range navigation tasks, such as UAV precision landings on rooftop pads within 30 meters. In contrast, larger arrays, such as a 12×12 configuration, can be deployed for long-range detection and navigation, enabling UAVs to locate landing zones from distances exceeding 50 meters.

### Onboard Computing for Low-Altitude UAV Operations.

The marking system transforms fiducial markers from passive localization aids into active components of the UAV's control loop by embedding navigation data that directly supports dynamic flight control. These mmWave markers not only enable precise localization through range and Angle of Arrival (AoA) measurements but also encode critical navigation-related information, such as trajectory adjustments, safe corridors, and alignment guidance, to actively aid UAVs during low-altitude operations.

To estimate pose, the UAV-mounted mmWave radar leverages AoA measurements by analyzing phase shifts in the reflected signals across its antenna array. When the radar emits a signal toward the marker's array of corner reflectors, the reflected waves arrive at different antennas with slight delays depending on their angle of incidence. This phase shift is directly related to the signal's wavelength, the spacing between antennas, and the angle of arrival. The radar calculates AoA using the relationship

$$θ = {sin}^{- 1} ( \frac{Δ ϕ λ}{2 π d} )$$

where Δφ is the phase difference, λ is the wavelength, and d is the spacing between antennas. By combining AoA with range data derived from the time-of-flight of the radar signal, the UAV determines its 3D position and orientation (yaw, pitch, and roll) relative to the marker. This method avoids the computationally intensive 3D-2D projections or feature-matching required in vision-based systems, enabling efficient real-time localization and control.

The embedded navigation data in the markers further extends their role by actively supporting UAV flight control. For example, during precision landings, the markers not only provide spatial localization but also encode descent guidelines, such as optimal approach angles, safe lateral offsets, and velocity thresholds to ensure smooth touchdowns. Consider a UAV landing on a rooftop pad equipped with a reflector array: AoA measurements allow the UAV to align itself with the pad's centerline, while frequency-encoded data provides dynamic descent instructions to counteract wind disturbances. This real-time feedback enables the UAV to adaptively adjust thrust, yaw, and roll to ensure a stable and precise landing, even in adverse conditions such as crosswinds or low visibility.

During low-altitude cruising near infrastructure, such as bridges or utility poles, the markers actively define safe flight corridors. The encoded data specifies lateral and vertical offsets for collision avoidance and trajectory alignment. For example, while inspecting a bridge, the markers can encode curvature data and elevation constraints, enabling the UAV to maintain a predefined path. The UAV's radar processes range and AoA data to dynamically adjust its position in response to environmental factors, such as wind or signal reflections. This active guidance reduces the computational burden on the UAV's onboard systems by offloading part of the navigation task to the markers.

The robustness of the marking system is further enhanced by the integration of frequency-selective surfaces (FSS) into the markers, which filter environmental noise to ensure reliable communication with the UAV. The encoded data also includes unique identifiers and checksum values, allowing the UAV to verify the authenticity and integrity of the markers. This mitigates risks associated with tampering or spoofing, ensuring that the control decisions based on the marker data are secure and accurate.

By combining precise AoA-based localization with embedded navigation guidance, the markers seamlessly integrate into the UAV's control loop. They provide real-time feedback for adaptive maneuvering, enabling precise and reliable low-altitude operations. This design shifts the role of fiducial markers from passive localization tools to active contributors to UAV stability and safety.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### Testing

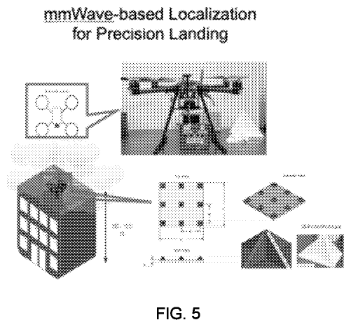

Referring to FIG. 5, a designated marker is shown that utilizes a matrix of corner reflectors in the form of pyramids. To convey logic and represent a predefined ID number, a mmWave radar was used to capture the reflected signal, which was then processed by a radar processing program in MATLAB. The MATLAB program was able to produce image ID.759. In the radar heatmap image we can see the exact matrix pattern in the form of heatblobs that corresponds to the predefined ID.759. The image ID.759 was processed by a high-level programming language, such as Python, capable of determining the ID number based on what the program detects in image ID.759. In some embodiments, Computer Vision can be used to recognize the pattern of the matrix. The matrix can also be recognized by training an Artificial Intelligence model by inputting multiple images of different ID numbers in different rotations to automatically recognize or detect a particular pattern.

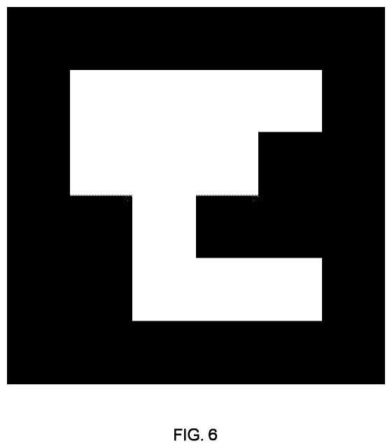

For example, ID number 24 may be extracted using an algorithm as shown in FIG. 6. An ArUco library assigns pattern number 24, a Modern camera enabled Computer Vision extracts the ID number using a data extraction method and compares the ID number to a library of different combinations. The ID number can still be read even if a few squares are slightly different due to bad lighting or camera glare. Since, by default, the program chose the ID number with the least number of errors (hamming distance). All orientations are taken into consideration with the entire ArUco library so the option with the least hamming distance was chosen for the correct ID number.

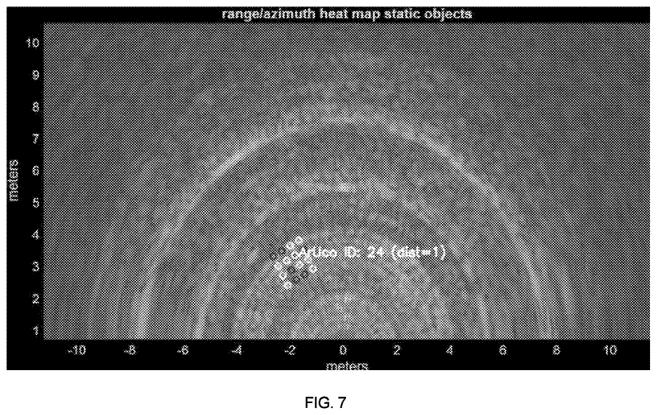

During testing, a mmWave radar was used to extract the ID number since traditional camera require optimal lighting and weather conditions. The mmWave radar was able to show a pattern of the marker regardless of the lighting or weather conditions. In FIG. 7, a Python CV debug image output with ID number 24 is shown with a hamming distance of 1 (one bit was read incorrectly) corresponding to the hamming distance of 1. The matrix on the heatmap was not orientated upright compared to FIG. 6, but the system was still able to extract ID number 24.

### Computer-Implemented System

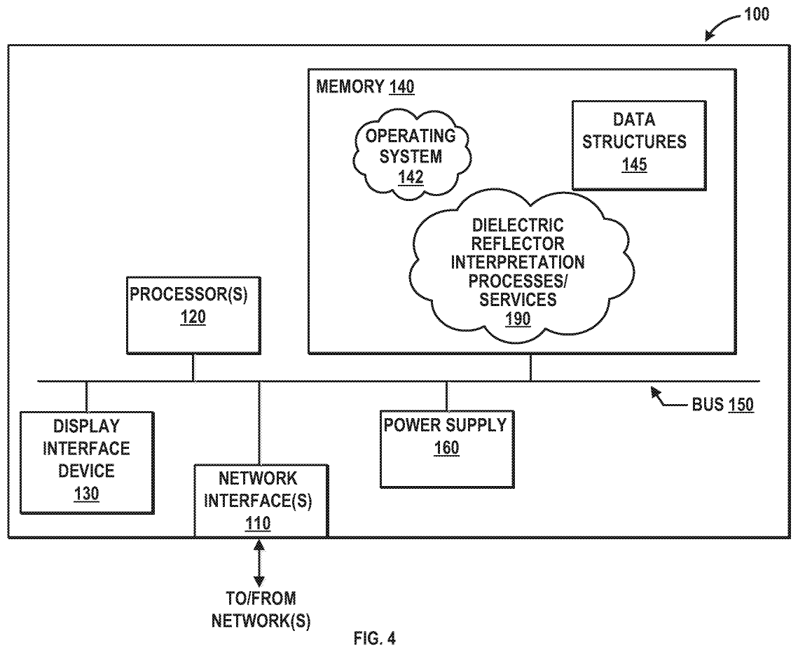

FIG. 4 is a schematic block diagram of an example device 100 that may be used with one or more embodiments described herein, e.g., as a component of a computing device onboard an unmanned aerial vehicle for controlling a radar device and decoding one or more of spatial, identity, and security-critical information within response signals received from a dielectric reflector.

Device 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.). Device 100 can also include or otherwise communicate with a display interface device 130 which can include one or more input/output devices that enable communication of data such as control outputs applied to a radar device and information received back from the radar device, as well as control devices for actuation of the unmanned aerial vehicle.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the systems and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes device 100 by, inter alia, invoking operations in support of software processes and/or services executing on the device. These software processes and/or services may include dielectric reflector interpretation processes/services 190, which can include aspects of the methods and/or implementations of various modules described herein. Note that while dielectric reflector interpretation processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the dielectric reflector interpretation processes/services 190 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a dielectric reflector arranged along a surface and having a frequency-selective surface that encodes one or more of spatial, identity, and security-critical information readable by a radar device of an unmanned aerial vehicle, wherein the security-critical information comprises verification information indicative of authenticity or tamper detection.

2. The system of claim 1, the dielectric reflector including a plurality of internal layers each having frequency-selective surfaces that selectively filter mmWave radar signals within a specified sub-band, resulting in a unique spectral signature readable by the unmanned aerial vehicle.

3. The system of claim 1, the dielectric reflector being one of a plurality of dielectric reflectors arranged in a reflector array pattern and having a unique spatial arrangement.

4. The system of claim 3, the reflector array pattern encoding one or more of spatial, identity, and security-critical information readable by the unmanned aerial vehicle.

5. The system of claim 1, the dielectric reflector forming part of a façade of a building.

6. The system of claim 1, further comprising:
a processor in communication with a memory onboard the unmanned aerial vehicle, the processor being in communication with the radar device, and the memory including instructions executable by the processor to:
generate, at the radar device of an unmanned aerial vehicle, a radar signal;
measure, at the radar device, a response signal from the dielectric reflector arranged along a surface; and
decode one or more of spatial, identity, and security-critical information based on the response signal.

7. The system of claim 6, the memory further including instructions executable by the processor to:
evaluate an angle of arrival (AoA) measurement for the unmanned aerial vehicle based on a phase shift between the response signal arriving at a first antenna of the radar device and a second antenna of the radar device; and
determine, based on the AoA measurement and a set of range data derived from a time-of-flight of the radar signal, a 3D position and orientation of the unmanned aerial vehicle relative to the dielectric reflector.

8. The system of claim 6, the memory further including instructions executable by the processor to:
generate a control input for application to an actuator of the unmanned aerial vehicle based on one or more of spatial, identity, and the security-critical information obtained from the response signal.

9. The system of claim 1, wherein the dielectric reflector encodes, in the response signal, data specifying lateral and vertical offsets for collision avoidance and trajectory alignment for the unmanned aerial vehicle with respect to a structure associated with the dielectric reflector.

10. The system of claim 1, wherein the dielectric reflector encodes, in the response signal, verification information comprising a security value for verification of authenticity of the dielectric reflector by the unmanned aerial vehicle.

11. A method, comprising:
generating, at a radar device of an unmanned aerial vehicle, a radar signal;
measuring, at the radar device, a response signal from a dielectric reflector arranged along a surface; and
decoding, at a processor of the unmanned aerial vehicle, one or more of spatial, identity, and security-critical information based on the response signal.

12. The method of claim 11, further comprising:
evaluating, at the processor, an angle of arrival (AoA) measurement for the unmanned aerial vehicle based on a phase shift between the response signal arriving at a first antenna of the radar device and a second antenna of the radar device; and
determining, at the processor and based on the AoA measurement and a set of range data derived from a time-of-flight of the radar signal, a 3D position and orientation of the unmanned aerial vehicle relative to the dielectric reflector.

13. The method of claim 11, further comprising:
determining, at the processor and based on the response signal, one or more of a lateral offset and a vertical offset for collision avoidance and trajectory alignment for the unmanned aerial vehicle with respect to a structure associated with the dielectric reflector.

14. The method of claim 11, further comprising:
generating a control input for application to an actuator of the unmanned aerial vehicle based on one or more of spatial, identity, and security-critical information obtained from the response signal.

15. A method, comprising:
forming, by an additive-manufacturing method, a dielectric reflector for arrangement along a surface, the dielectric reflector having a frequency-selective surface that encodes one or more of spatial, identity, and security-critical information readable by a radar device of an unmanned aerial vehicle, wherein the security-critical information comprises verification information indicative of authenticity or tamper detection.

16. The method of claim 15, the dielectric reflector including a plurality of internal layers covered by frequency selective surfaces that selectively filter mmWave radar signals within a specified sub-band resulting in a unique spectral signature readable by the unmanned aerial vehicle.

17. The system of claim 1, wherein the dielectric reflector comprises a multifaceted corner reflector having a dihedral structure or a trihedral structure and configured to retroreflect millimeter-wave signals toward the radar device across a range of incidence angles.

18. The system of claim 3, wherein at least a subset of cells of the reflector array pattern are configured to introduce a frequency notch at about 77 GHz by the frequency-selective surface, and wherein the frequency-selective surface includes split-ring resonators or periodic slots to produce the frequency notch.

19. The system of claim 3, wherein the reflector array pattern includes a marker array having a 6×6 arrangement of dielectric reflectors for close-range navigation and a 12×12 arrangement of dielectric reflectors for long-range detection and navigation.

20. The method of claim 11, further comprising authenticating the dielectric reflector by cross-checking spatially decoded identity information against spectrally decoded verification information and determining tampering based on a failure of the cross-check.
